(19) United States
(12) Patent Application Publication
(10) Pub. No.: US 2024/0428300 A1
(43) Pub. Date: Dec. 26, 2024

(54) PRESENTATION AND CONTROL OF USER INTERACTION WITH A MULTI-TAB USER INTERFACE ELEMENT

(71) Applicant: Capital One Services, LLC, McLean, VA (US)

(72) Inventors: Thomas DOHAN, II, Elmhurst, IL (US); Erik Jay Salazar DE LEON, Richmond, VA (US); Xiang LAN, South Orange, NJ (US); Min Jung KIM, Fairfax, VA (US); Brett William BISHOP, Golden, CO (US); John HEINER, Midlothian, VA (US)

(21) Appl. No.: 18/829,913

(22) Filed: Sep. 10, 2024

Related U.S. Application Data
(63) Continuation of application No. 17/649,997, filed on Feb. 4, 2022.

(51) Int. Cl. G06Q 30/0282; G06F 3/0483; G06Q 30/0204

(52) U.S. Cl. CPC G06Q 30/0282; G06F 3/0483; G06Q 30/0205

(57) ABSTRACT

In some implementations, a system may identify one or more account identifiers associated with a user identifier. Each account identifier may be associated with one or more categories each representing a type of interaction of one or more interactions associated with the account identifier. A respective interaction amount may be associated with each interaction. The system may determine, for each category, a total category amount that is a sum of interaction amounts for interactions in a particular category occurring within a particular time frame. The system may transmit user interface (UI) data associated with a multi-tab UI element including a plurality of tabs corresponding to the plurality of categories. Each tab may be associated with benefits information related to a category corresponding to that tab. A first tab, corresponding to a category having a highest total category amount, may be presented in a particular position in the multi-tab UI element.

### RELATED APPLICATION

This application is a continuation of U.S. patent application Ser. No. 17/649,997, filed Feb. 4, 2022, which is incorporated herein by reference in its entirety.

### BACKGROUND

A display of a user device may display a user interface (e.g., a graphical user interface). A user interface may permit interactions between a user of the user device and the user device. In some cases, the user may interact with the user interface to operate and/or control the user device to produce a desired result. For example, the user may interact with the user interface of the user device to cause the user device to perform an action. Additionally, the user interface may provide information to the user.

### SUMMARY

Some implementations described herein relate to a system for providing data for presentation of a multi-tab user interface element. The system may include one or more memories and one or more processors communicatively coupled to the one or more memories. The one or more processors may be configured to identify, based on a user identifier associated with a user account, one or more account identifiers associated with the user identifier. The one or more processors may be configured to determine, for each category of the plurality of categories, a total category amount, wherein the total category amount is a sum of interaction amounts for a plurality of interactions in a particular category, of the plurality of categories, that occur within a particular time frame. The one or more processors may be configured to transmit, to a user device, user interface data associated with the multi-tab user interface element to be displayed on a display of the user device.

Some implementations described herein relate to a method for providing data for presenting a multi-tab user interface element. The method may include receiving, by a system and from a user device of a user, a request for benefits information related to a plurality of categories of interactions associated with an account of the user. The method may include obtaining, by the system and from a user profile database, a set of data indicating interaction amounts for a plurality of interactions associated with the plurality of categories for a particular time frame. The method may include determining, by the system and for each category, a total category amount based on the interaction amounts indicated in the set of data. The method may include transmitting, by the system and to the user device, user interface data associated with the multi-tab user interface element to be displayed on a display of the user device, where the user interface data indicates a plurality of tabs corresponding to the plurality of categories. The method may include identifying, by the system, a tab, of the plurality of tabs, to be an active tab corresponding to a category, of the plurality of categories, having a highest total category amount out of the plurality of categories. The method may include determining, by the system, the benefits information related to a category, of the plurality of categories, corresponding to the active tab. The method may include transmitting, by the system and to the user device, the benefits information to be displayed on the display of the user device.

Some implementations described herein relate to a user device configured to present a multi-tab user interface element. The user device may include a memory and one or more processors communicatively coupled to the memory. The one or more processors may be configured to present, on a user interface associated with a user account, an interaction element. The one or more processors may be configured to detect a user interaction, with the user device, that indicates the interaction element. The one or more processors may be configured to present, on the user interface and based on the user interaction, the multi-tab user interface element that includes a plurality of tabs corresponding to a plurality of categories associated with the user account. The one or more processors may be configured to present, on the user interface, benefits information related to a category, of the plurality of categories, corresponding to a first tab of the plurality of tabs, wherein the first tab is first in the order of the plurality of tabs.

### BRIEF DESCRIPTION OF THE DRAWINGS

FIGS. 1A-1E are diagrams of an example implementation relating to presentation and control of user interaction with a multi-tab user interface element.

FIG. 2 is a diagram of an example environment in which systems and/or methods described herein may be implemented.

FIG. 3 is a diagram of example components of one or more devices of FIG. 2.

FIGS. 4-6 are flowcharts of example processes relating to presentation and control of user interaction with a multi-tab user interface element.

### DETAILED DESCRIPTION

The following detailed description of example implementations refers to the accompanying drawings. The same reference numbers in different drawings may identify the same or similar elements.

A user may participate in various activities (e.g., engaging in interactions with one or more third parties) via one or more accounts associated with the user. An institution operating the account(s) may maintain records of data corresponding to each activity, including a particular category (e.g., entertainment, dining, travel, shopping) in which the corresponding activity falls, for each account. In some instances, the user may want to derive certain insights and/or perform certain actions related to the user's participation in the various activities in a quick and efficient manner. For example, the user may want to switch from viewing insights related to one category to insights related to another category. However, techniques frequently involve presenting the data for different categories on a user interface (UI) in chronological order of when the events occurred and/or in list form. Additionally, the data is often segregated by accounts and/or categories. As a result, the user must inefficiently determine any insights by navigating through UIs for different sets of data presented on the UIs. Furthermore, requiring the user to navigate through different UIs inefficiently utilizes computing resources. Thus, it is desirable for a UI to provide a user-friendly and efficient way for a user to visualize and gain insights from the data.

Some implementations described herein enable a system to provide data for presentation of a UI element on a user device that separates information related to different categories (e.g., entertainment, dining, travel, shopping) in different tabs of the UI element. The tabs may be arranged in an order based on category amounts associated with the categories corresponding to the tabs. Accordingly, by incorporating the information for the different categories in the UI element, rather than providing and presenting the information in multiple UIs and/or UI elements, computing resources can be conserved.

In some implementations described herein, a system may obtain a set of data indicating interaction amounts associated with multiple interactions between a user and one or more third parties that occur within a particular time frame. Each of the interactions may be associated with a category, and for each category, the system may determine a total category amount (e.g., a sum of the interaction amounts for the particular category in the set of data). A UI element to be displayed on a user device of the user may include multiple tabs corresponding to the categories, and each tab may be associated with benefits information requested by the user and related to a category corresponding to that tab. An order of the tabs may be based on the total category amounts for the categories. For example, a first tab may be presented in a particular position in the UI element, where the first tab corresponds to a category having the highest total category amount. In some implementations described herein, the tabs may be arranged in a decreasing order of total category amounts of the corresponding categories.

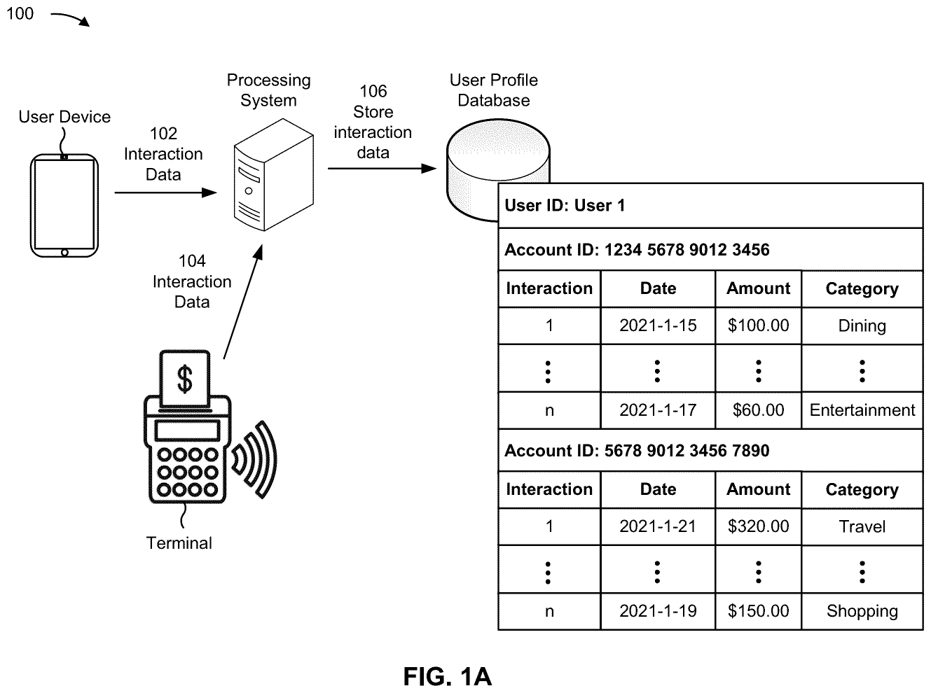

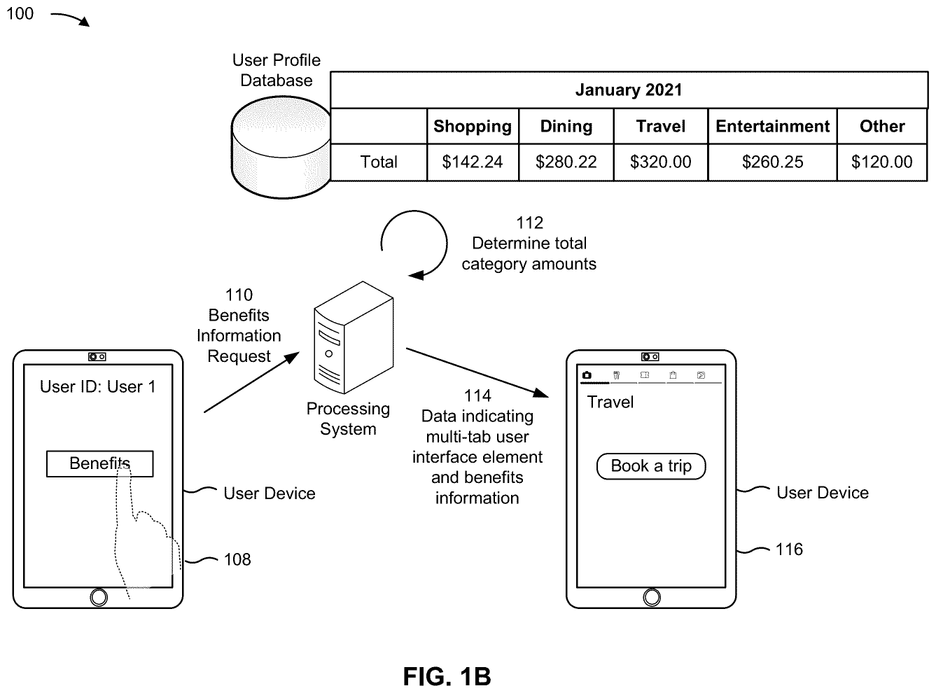

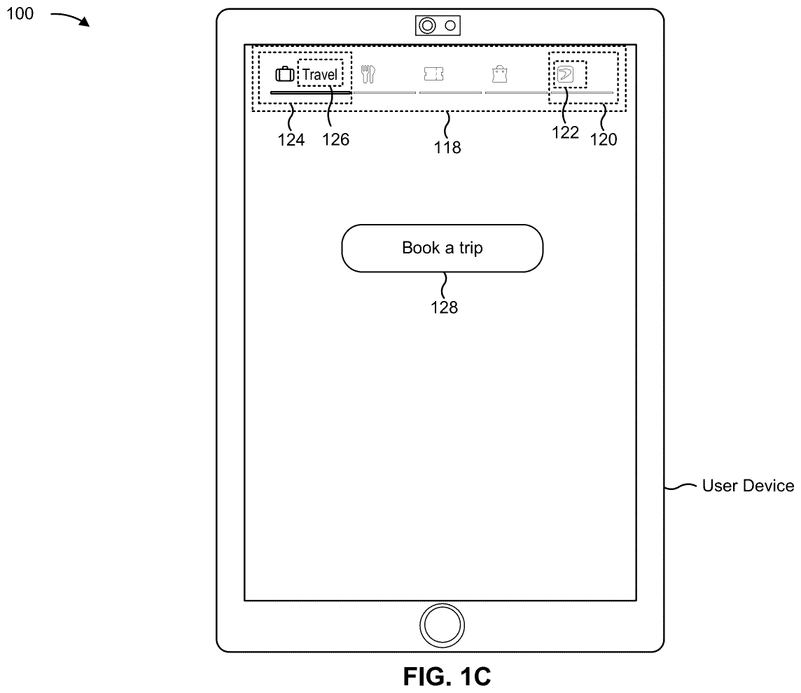

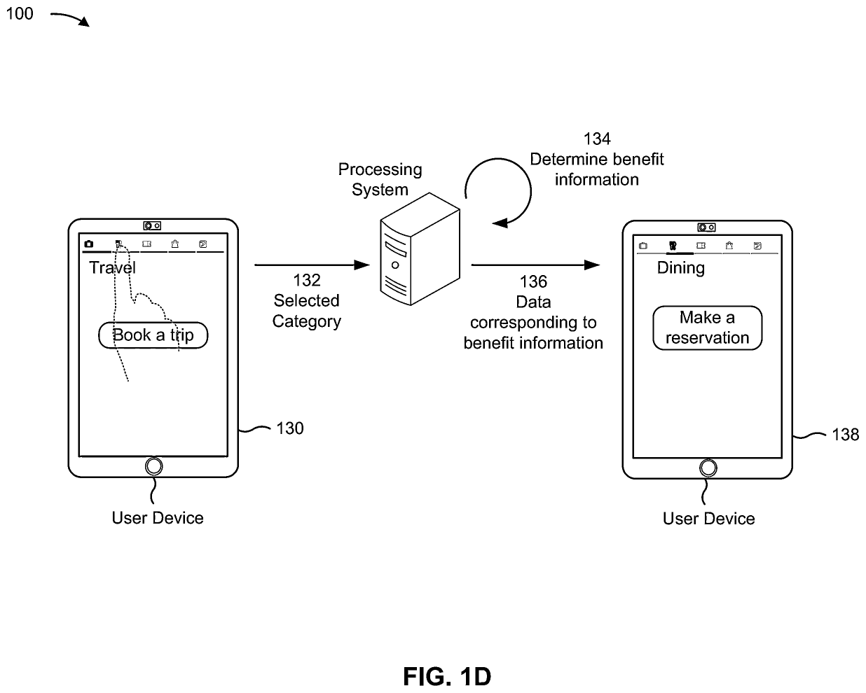

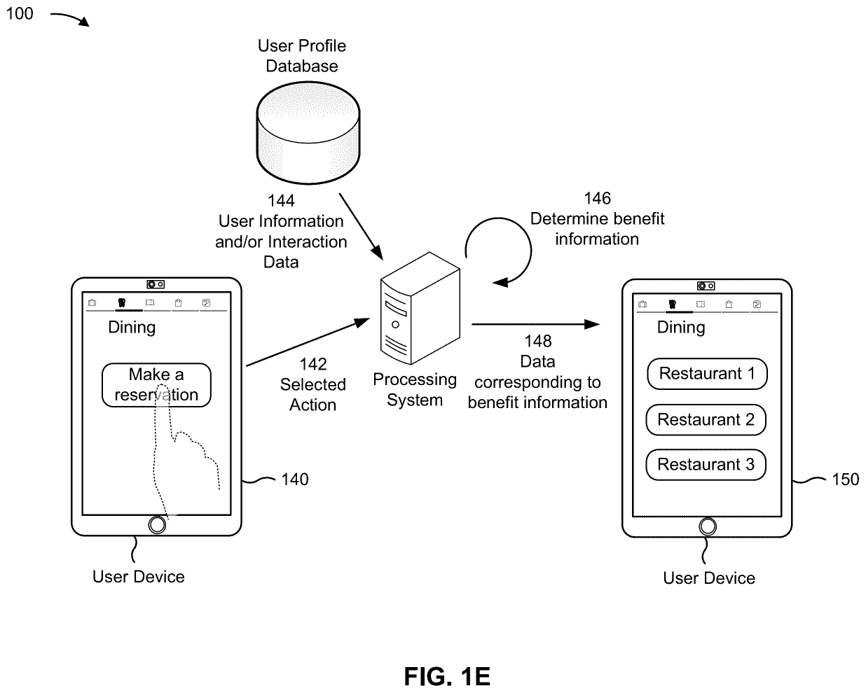

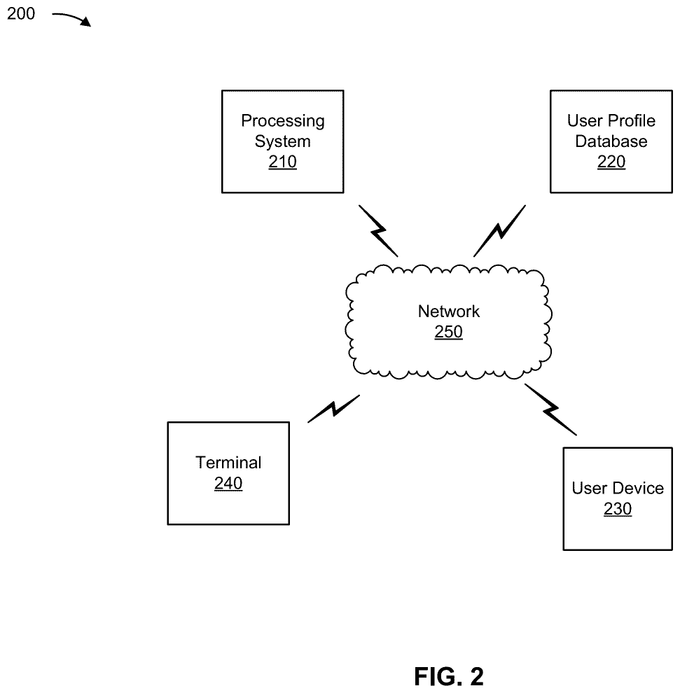

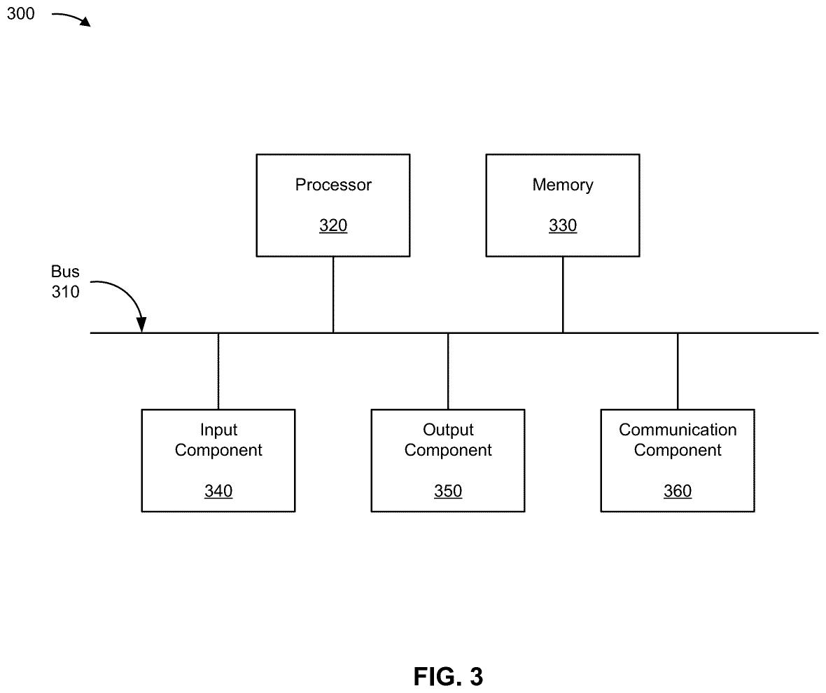

FIGS. 1A-1E are diagrams of an example 100 associated with presentation and control of user interaction with a multi-tab user interface element. As shown in FIGS. 1A-1E, example 100 includes a processing system, a user profile database, a user device, and a terminal. These devices are described in more detail in connection with FIGS. 2 and 3.

As shown in FIG. 1A, a user may engage in an interaction with a third party (e.g., a merchant or a service provider). For example, the user may perform the interaction via the user device (e.g., in an online interaction), and the processing system may receive interaction data associated with the interaction from the user device, as shown by reference number 102, such as over a network, as described in more detail hereinafter. As another example, the user may perform the interaction at a terminal (e.g., a point-of-sale (POS) terminal at a location of the third party), and the processing system may receive interaction data associated with the interaction from the terminal, as shown by reference number 104, such as over the network. The interaction data may indicate a time of the interaction and an interaction amount.

As shown by reference number 106, the processing system may store the interaction data (e.g., in a user profile database) under a user account associated with the user. The user and/or the user account may be associated with a unique user identifier (e.g., a username). In some implementations, the user may have multiple accounts with which the user may perform the interaction. The accounts may have corresponding unique account identifiers (e.g., an account ID number, a primary account number (PAN), or a virtual card number) that may be associated with the user identifier. The interaction data may include the account identifier used in the particular interaction, and the processing system may store the interaction data (e.g., interaction amount and interaction date) in the user profile database in association with the particular account identifier and/or the user identifier.

As further shown in FIG. 1A, each interaction may be associated with a category (e.g., dining, entertainment, travel, shopping, or other), which may represent a type of interaction of the particular interaction by the user, when the corresponding interaction data is stored in the user profile database. In some implementations, the interaction data received by the processing system may indicate the category for the corresponding interaction. Alternatively, the processing system may categorize the interaction, with one or more categories of multiple possible categories, based on the interaction data.

For example, the processing system may categorize the interaction based on the interaction data (e.g., interaction amount and/or the interaction time) and one or more associated rules or conditions. For example, if the interaction data indicates that the interaction occurred in the morning (e.g., before 10:00 AM) and is less than a threshold amount (e.g., $10), the processing system may categorize the interaction as dining (e.g., for coffee or breakfast). As another example, if the interaction data indicates a location of the interaction (e.g., a zip code and/or geographic coordinates) that is a threshold distance away from an address and/or location associated with the user's account, and the interaction data further indicates that the interaction occurred during a holiday or within a threshold time frame from the holiday, the processing system may categorize the interaction as travel.

In some implementations, the interaction data may additionally indicate third party information associated with the third party from the interaction. The third party information may include a third party identifier (e.g., a third party name or a unique identifier), by which the processing system may identify the third party, and/or a third party type (e.g., movie theater, restaurant, hotel, grocery store). Each third party identifier and/or third party type may be associated with one or more of the possible categories, for example, in a third party entity database. As a result, the processing system may use the third party information to identify a corresponding category with which to categorize the interaction (e.g., by searching the third party entity database for the third party identifier and/or third party type). Additionally, or alternatively, the processing system may have one or more rules or conditions to determine the category from the third party information. For example, if the third party information indicates a movie theater or an amusement park as the third party type, then the processing system may categorize the interaction as entertainment. As another example, if the third party information indicates a hotel or an airline as the third party type, then the processing system may categorize the interaction as travel. As another example, if the third party information indicates a restaurant as the third party type, then the processing system may categorize the interaction as dining. As yet another example, if the third party information indicates a retail or grocery third party type, then the processing system may categorize the interaction as shopping.

In some implementations, the user may manually indicate a category, from the multiple possible categories, for a particular interaction. The user may indicate the category at the time of the interaction (e.g., when the interaction is performed via the user device). For example, after the processing system has received the interaction data (e.g., from the user device or from the terminal), the processing system may transmit a message to the user device (e.g., via electronic mail, a short message serve (SMS) message, or a message internal to an application stored on the user device) requesting the user's input for the category. The user may select a category from a list of possible categories or may manually input a category (e.g., in a dedicated entry field displayed on the user device via the application). Additionally, or alternatively, the user may indicate the category after the interaction data has been stored in the user profile database and the user has accessed the interaction data via the user device (e.g., via the application stored on the user device or a web-based application accessed by the user device over the network). In a similar manner, the user may change categories automatically applied to interactions by the processing system.

In some implementations, the processing system may use a machine learning model to determine the category. For example, the machine learning model may be a supervised machine learning model trained based on the interaction data and/or categories manually input by the user for particular interactions. Additionally, or alternatively, the machine learning model may be an unsupervised machine learning model trained based on one or more clusters of users that have similar interactions and/or demographics (e.g., age range, income range, or sex).

In some instances, more than one category may be applicable to an interaction. For example, if the interaction data indicates that the interaction occurred at a particular venue (e.g., as indicated by the third party information) during a dining time of day (e.g., as indicated by the interaction time), then the processing system may determine that the interaction could be categorized as entertainment or dining. In such an instance, the processing system may search historical interaction data of the user and/or of other users to identify one or more past interactions that include the venue or a similar venue (e.g., a venue having a similar third party type) and/or that occurred at a similar time of day (e.g., within a threshold time frame of the time of the interaction). The processing system may then categorize the interaction with the category associated with the identified past interaction of the user. If the user does not have a similar interaction in the user's historical interaction data, then the processing system may categorize the interaction based on the most widely used category (e.g., having the highest count) for a similar interaction.

As shown in FIG. 1B, the user may initiate a request for information (e.g., benefits information) about the user's account(s) from the user device (e.g., via the application stored on the user device or via the web-based application accessed by the user device over the network). For example, as shown by reference number 108, the user may input the request via the user device by selecting a dedicated option (or interaction element) to access the information (e.g., via a button on a touchscreen display of the user device), and the user device may detect the user interaction with the interaction element. Additionally, the user may specify a time frame (e.g., calendar month) for which the user would like the information. Alternatively, the time frame may be a default time frame (e.g., the current calendar month, the previous calendar month, a group of the most recent months, the current calendar year). The time frame may be included in the information request. As shown by reference number 110, the processing system may receive (e.g., from the user device) data indicating the information request. The information request may include or may be accompanied by data indicating the user identifier. Additionally, or alternatively, the processing system may have already received the user identifier from the user device, for example, when the user logged into the user's account via the application stored on the user device or via the web-based application.

Based on the user identifier, the processing system may identify one or more account identifiers associated with the user identifier, and may access and/or obtain (e.g., from the user profile database) the historical interaction data associated with each account identifier. From the historical interaction data, the processing system may identify and/or obtain a set of data indicating interaction amounts for one or more interactions associated with the one or more categories. As shown by reference number 112, the processing system may determine, for each category of the one or more categories, a total category amount, which may be a sum of interaction amounts for the one or more interactions in the particular category that occur within a particular time frame (e.g., the specified time frame or default time frame). The total category amount may be determined separately for each account identifier, or may be determined cumulatively across all of the account identifiers.

Based on the total interaction amounts for each category, the processing system may determine characteristics of the multi-tab UI element and the information (e.g., benefits information) requested by the user, as described in more detail hereinafter. As shown by reference number 114, the processing system may transmit, to the user device, UI data indicating a multi-tab UI element and benefits information to be displayed on a display of the user device. As shown by reference number 116, the user device may display the multi-tab UI element and benefits information.

As shown in FIG. 1C, the multi-tab UI element, as indicated by the UI data, may include a hub 118 of one or more tabs 120 corresponding to the one or more categories associated with the account identifier(s). Each tab 120 may be associated with information (e.g., benefits information) related to a category corresponding to that tab 120. Each tab may include an icon 122 representative of the particular category. For example, a tab 120 corresponding to a category for travel may have an icon 122 of a suitcase or an airplane. As another example, a tab 120 corresponding to a category for dining may have an icon 122 of a fork, knife, and/or plate. As another example, a tab 120 corresponding to a category for entertainment may have an icon 122 of a ticket stub or popcorn. As another example, a tab 120 corresponding to a category for shopping may have an icon 122 of a shopping bag.

The tabs 120 may be arranged in an order in which a first tab of the tabs 120 may be presented in a particular position (e.g., a left-most position) in the hub 118 of the multi-tab UI element. The order may be based on the total category amounts determined by the processing system for each category. For example, the tabs 120 may be ordered after the first tab by decreasing total category amounts associated with categories corresponding to the tabs (e.g., the first (left-most) tab corresponds to a category having the highest total category amount). One of the tabs 120 may be an active tab 124 for which information (e.g., benefits information) may be displayed. When the user device first displays the multi-tab UI element, the first tab may be the active tab 124 by default. The user may subsequently change which tab 120 is the active tab 124, as described in more detail hereinafter. The active tab 124 may include the category name 126 in addition to the icon 122.

As further shown in FIG. 1C, the requested information (e.g., benefits information) may include information that identifies a selectable option or action button 128 (e.g., a second interaction element), which may be associated with the category corresponding to the active tab 124 (e.g., the active or selected category). The action button 128 may be part of the requested information related to the active category. Additionally, or alternatively, interaction with the action button 128 may result in the requested information related to the active category being displayed, as described in more detail below in connection with FIG. 1E. The action button 128 may indicate a particular action related to the active category to be performed by the processing system and/or the user (e.g., making a reservation, booking a trip, identifying shopping deals, or the like).

As shown in FIG. 1D, if the user desires to obtain the requested information (e.g., benefits information) for a particular category other than the category corresponding to the first tab, the user may select the tab corresponding to the particular category. Each tab may be selectable and/or interactable. As shown by reference number 130, the user device may detect a user interaction with and selection of the particular tab (e.g., via a touchscreen of the user device). As shown by reference number 132, the processing system may receive interaction data indicating the user interaction and/or the particular tab. From the interaction data, the processing system may determine the category selected by the user (e.g., the selected category). Alternatively, the interaction data may indicate the selected category. As shown by reference number 134, the processing system may determine the requested information (e.g., benefits information) corresponding to the selected category. As shown by reference number 136, the processing system may transmit UI data indicating an updated multi-tab UI element in which the selected tab is shown as the active tab, and the requested information corresponding to the selected category is presented with the multi-tab UI element. The requested information may include an action button (or second interaction element). As shown by reference number 138, the user device may display the updated multi-tab UI element.

As shown in FIG. 1E, the user may select (e.g., interact with) the second interaction element of the multi-tab UI element. As shown by reference number 140, the user device may detect the interaction with the second interaction element. As shown by reference number 142, the processing system may receive interaction data indicating the interaction with the second interaction element and/or the selected action associated with the second interaction element (e.g., make a reservation, book a trip). As shown by reference number 144, the processing system may obtain (e.g., from the user profile database) user profile data indicating user information associated with the account of the user and/or information associated with one or more interactions (e.g., historical interaction data). For example, the user information may include a geographic location of the user and/or demographic information of the user, and the historical interaction data may include date(s) of the interaction(s), geographic location(s) of the interaction(s), third party identifiers of the third parties with which the interaction(s) were performed, and/or interaction amounts.

As shown by reference number 146, the processing system may determine benefit information related to the selected action and based on the user information and/or interaction data. For example, if the selected action is to “Make a Reservation”, then the benefit information may include a list of restaurants based on the on the user information and/or interaction data, such as restaurants at which the user has previously dined (e.g., within a threshold time frame, such as within the past year), similar types of restaurants (e.g., type of cuisine and/or price point), and/or near the user's geographic location (e.g., within a threshold distance, such as 10 miles). The processing system may obtain the benefit information from a third party server and/or database of information related to the action and/or category. As shown by reference number 148, the processing system may transmit data corresponding to the benefit information to the user device. As shown by reference number 150, the user device may display the benefit information as part of the multi-tab UI element.

In some implementations, the processing system may use a machine learning model to determine the benefit information. For example, the machine learning model may be a supervised machine learning model trained based on the interaction data (e.g., interaction amounts, third party identifiers, geographic location of the user) obtained from the user profile database. Additionally, or alternatively, the machine learning model may be an unsupervised machine learning model trained based on one or more clusters of users that have similar interactions and/or demographic information of the user (e.g., age range, income range, or sex).

Using the techniques described herein, a user device may present, on a UI, a multi-tab UI element that provides user-friendly visualization that aggregates comparative information to enable a user to efficiently gain insights about the user's account(s). Additionally, the multi-tab UI element dynamically presents the information to the user, as the visualization changes for the user based on changes in the user's account information (e.g., interaction data). Further, the multi-tab UI element, as presented on the user device, is unique and personalized to each user as the multi-tab UI element is based on each user's personal account information (e.g., interaction data).

As indicated above, FIGS. 1A-1E are provided as an example. Other examples may differ from what is described with regard to FIGS. 1A-1E.

FIG. 2 is a diagram of an example environment 200 in which systems and/or methods described herein may be implemented. As shown in FIG. 2, environment 200 may include a processing system 210, a user profile database 220, a user device 230, a terminal 240, and a network 250. Devices of environment 200 may interconnect via wired connections, wireless connections, or a combination of wired and wireless connections.

The processing system 210 includes one or more devices capable of receiving, generating, storing, processing, providing, and/or routing information associated with presentation and control of user interaction with a multi-tab user interface element, as described elsewhere herein. The processing system 210 may include a communication device and/or a computing device. For example, the processing system 210 may include a server, such as an application server, a client server, a web server, a database server, a host server, a proxy server, a virtual server (e.g., executing on computing hardware), or a server in a cloud computing system. In some implementations, the processing system 210 includes computing hardware used in a cloud computing environment.

The user profile database 220 includes one or more devices capable of receiving, generating, storing, processing, and/or providing information associated with presentation and control of user interaction with a multi-tab user interface element, as described elsewhere herein. The user profile database 220 may include a communication device and/or a computing device. For example, the user profile database 220 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the user profile database 220 may store information associated with an account of a user, such as interaction data associated with interactions between the user and a third party, as described elsewhere herein.

The user device 230 includes one or more devices capable of receiving, generating, storing, processing, and/or providing information associated with presentation and control of user interaction with a multi-tab user interface element, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The terminal 240 includes one or more devices capable of facilitating an electronic transaction. For example, the terminal 240 may include a point-of-sale (POS) terminal, a payment terminal (e.g., a credit card terminal, a contactless payment terminal, a mobile credit card reader, or a chip reader), and/or an automated teller machine (ATM). The terminal 240 may include one or more input components and/or one or more output components to facilitate obtaining data (e.g., account information) from a transaction device (e.g., a transaction card, a mobile device executing a payment application, or the like) and/or to facilitate interaction with and/or authorization from an owner or accountholder of the transaction device. Example input components of the terminal 240 include a number keypad, a touchscreen, a magnetic stripe reader, a chip reader, and/or a radio frequency (RF) signal reader (e.g., a near-field communication (NFC) reader). Example output devices of terminal 240 include a display and/or a speaker.

The network 250 includes one or more wired and/or wireless networks. For example, the network 250 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 250 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the processing system 210, the user profile database 220, the user device 230, and/or the terminal 240. In some implementations, the processing system 210, the user profile database 220, the user device 230, and/or the terminal 240 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

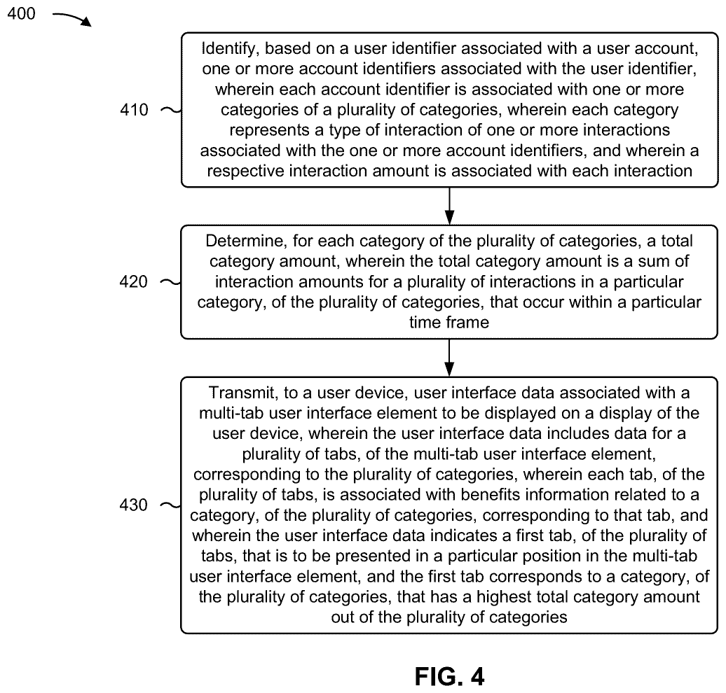

FIG. 4 is a flowchart of an example process 400 associated with presentation and control of user interaction with a multi-tab user interface element. In some implementations, one or more process blocks of FIG. 4 may be performed by a system (e.g., processing system 210). In some implementations, one or more process blocks of FIG. 4 may be performed by another device or a group of devices separate from or including the system, such as user device 230. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include identifying, based on a user identifier associated with a user account, one or more account identifiers associated with the user identifier, wherein each account identifier is associated with one or more categories of a plurality of categories, wherein each category represents a type of interaction of one or more interactions associated with the one or more account identifiers, and wherein a respective interaction amount is associated with each interaction (block 410). As further shown in FIG. 4, process 400 may include determining, for each category of the plurality of categories, a total category amount, wherein the total category amount is a sum of interaction amounts for a plurality of interactions in a particular category, of the plurality of categories, that occur within a particular time frame (block 420). As further shown in FIG. 4, process 400 may include transmitting, to a user device, user interface data associated with the multi-tab user interface element to be displayed on a display of the user device, wherein the user interface data includes data for a plurality of tabs, of the multi-tab user interface element, corresponding to the plurality of categories, wherein each tab, of the plurality of tabs, is associated with benefits information related to a category, of the plurality of categories, corresponding to that tab, and wherein the user interface data indicates a first tab, of the plurality of tabs, that is to be presented in a particular position in the multi-tab user interface element, and the first tab corresponds to a category, of the plurality of categories, that has a highest total category amount out of the plurality of categories (block 430).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

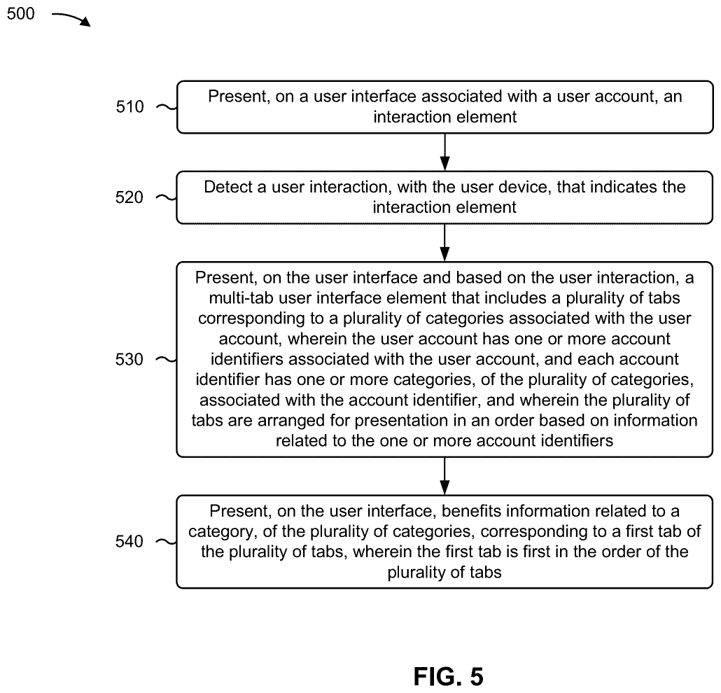

FIG. 5 is a flowchart of an example process 500 associated with presentation and control of user interaction with a multi-tab user interface element. In some implementations, one or more process blocks of FIG. 5 may be performed by a user device (e.g., user device 230). Additionally, or alternatively, one or more process blocks of FIG. 5 may be performed by one or more components of device 300, such as processor 320, memory 330, input component 340, output component 350, and/or communication component 360.

As shown in FIG. 5, process 500 may include presenting, on a user interface associated with a user account, an interaction element (block 510). As further shown in FIG. 5, process 500 may include detecting a user interaction, with the user device, that indicates the interaction element (block 520). As further shown in FIG. 5, process 500 may include presenting, on the user interface and based on the user interaction, a multi-tab user interface element that includes a plurality of tabs corresponding to a plurality of categories associated with the user account, wherein the user account has one or more account identifiers associated with the user account, and each account identifier has one or more categories, of the plurality of categories, associated with the account identifier, and wherein the plurality of tabs are arranged for presentation in an order based on account information related to the one or more account identifiers (block 530). As further shown in FIG. 5, process 500 may include presenting, on the user interface, benefits information related to a category, of the plurality of categories, corresponding to a first tab of the plurality of tabs, wherein the first tab is first in the order of the plurality of tabs (block 540).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

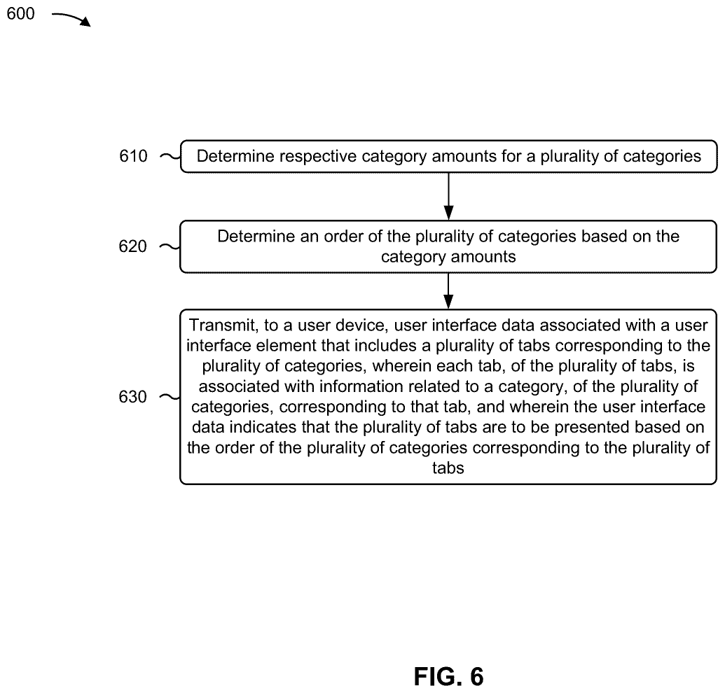

FIG. 6 is a flowchart of an example process 600 associated with presentation and control of user interaction with a multi-tab user interface element. In some implementations, one or more process blocks of FIG. 6 may be performed by a system (e.g., processing system 210) or a user device (e.g., user device 230). Additionally, or alternatively, one or more process blocks of FIG. 6 may be performed by one or more components of device 300, such as processor 320, memory 330, input component 340, output component 350, and/or communication component 360.

As shown in FIG. 6, process 600 may include determining respective category amounts for a plurality of categories (block 610). As further shown in FIG. 6, process 600 may include determining an order of the plurality of categories based on the category amounts (block 620). As further shown in FIG. 6, process 600 may include transmitting, to a user device, user interface data associated with a user interface element that includes a plurality of tabs corresponding to the plurality of categories (block 630). Each tab is associated with information related to a category, of the plurality of categories, corresponding to that tab. The user interface data indicates that the plurality of tabs are to be presented based on the order of the plurality of categories corresponding to the plurality of tabs.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
one or more memories; and
one or more processors, coupled to the one or more memories, configured to:
identify, based on a user identifier associated with a user account associated with a user, one or more account identifiers associated with the user identifier,
wherein each account identifier is associated with one or more categories of a plurality of categories that each represents a type of interaction of one or more interactions associated with the one or more account identifiers;
determine, for each category of the plurality of categories, a total category amount;
transmit, based on determining the total category amount and to a user device associated with the user, user interface data, associated with a multi-tab user interface element for a display of the user device, including:
a plurality of tabs corresponding to the plurality of categories and associated with benefits information associated with the user account, and
an action button associated with a first category of the plurality of categories;
receive, from the user device, information indicating a selection of the action button;
determine, based on receiving the information indicating the selection of the action button, benefits information associated with the first category using a machine model and based on geographical information associated with the user device and historical interaction amounts of the user; and
transmit, to the user device, updated user interface data, associated with the multi-tab user interface element, indicating the benefits information.

2. The system of claim 1, wherein the one or more processors are further configured to:
obtain interaction data associated with a plurality of interactions, including the one or more interactions, with a plurality of third parties across the plurality of categories, wherein the interaction data includes an account identifier of the one or more account identifiers; and
categorize, based on the interaction data, the plurality of interactions according to the plurality of categories.

3. The system of claim 2, wherein the interaction data comprises an interaction amount and an interaction time, and wherein the plurality of interactions are categorized based on one or more rules associated with the interactions amount and the interaction time.

4. The system of claim 2, wherein the interaction data comprises third party information associated with a third party of the plurality of third parties, and wherein the plurality of interactions are categorized based on one or more rules associated with the third party information.

5. The system of claim 2, wherein the interaction data is obtained from a plurality of terminals receiving the plurality of interactions.

6. The system of claim 2, wherein the plurality of interactions are categorized according to the plurality of categories using a machine model trained based on one or more of:
previous categories manually inputted by the user for previous interactions, or one or more users that have similar interactions.

7. A method, comprising:
identifying, based on a user identifier associated with a user account associated with a user, one or more account identifiers associated with the user identifier,
wherein each account identifier is associated with one or more categories of a plurality of categories that each represents a type of interaction of one or more interactions associated with the one or more account identifiers;
determining, by a device, for each category of the plurality of categories, a total category amount;
transmitting, based on determining the total category amount and to a user device associated with the user, user interface data, associated with a multi-tab user interface element for a display of the user device, including:
a plurality of tabs corresponding to the plurality of categories and associated with benefits information associated with the user account, and
an action button associated with a first category of the plurality of categories;
receiving, from the user device, information indicating a selection of the action button;
determining, based on receiving the information indicating the selection of the action button, benefits information associated with the first category using a machine model and based on geographical information associated with the user device and historical interaction amounts of the user; and
transmitting, by the device, to the user device, updated user interface data, associated with the multi-tab user interface element, indicating the benefits information.

8. The method of claim 7, further comprising:
determining, based on a plurality of interactions associated with the user and including the one or more actions, the benefits information associated with each of the plurality of categories.

9. The method of claim 7, wherein the action button is associated with one or more benefits associated with one or more third parties associated with the first category.

10. The method of claim 9, further comprising:
obtaining user information, the geographical information, and the historical interaction amounts.

11. The method of claim 7, further comprising:
obtaining interaction data associated with a plurality of interactions, including the one or more interactions, with a plurality of third parties across the plurality of categories, wherein the interaction data includes an account identifier of the one or more account identifiers; and
categorizing, based on the interaction data, the plurality of interactions according to the plurality of categories.

12. The method of claim 11, wherein the interaction data comprises an interaction amount and an interaction time, and wherein the plurality of interactions are categorized based on one or more rules associated with the interactions amount and the interaction time.

13. The method of claim 11, wherein the interaction data comprises third party information associated with a third party of the plurality of third parties, and wherein the plurality of interactions are categorized based on one or more rules associated with the third party information.

14. The method of claim 11, wherein the interaction data is obtained from a plurality of terminals receiving the plurality of interactions.

15. The method of claim 11, wherein the plurality of interactions are categorized according to the plurality of categories using a machine model trained based on one or more of:
previous categories manually inputted by the user for previous interactions, or one or more users that have similar interactions.

16. A non-transitory computer-readable medium storing a set of instructions, the set of instructions comprising:
one or more instructions that, when executed by one or more processors of a device, cause the device to:
identify, based on a user identifier associated with a user account associated with a user, one or more account identifiers associated with the user identifier,
wherein each account identifier is associated with one or more categories of a plurality of categories that each represents a type of interaction of one or more interactions associated with the one or more account identifiers;
determine, for each category of the plurality of categories, a total category amount;
transmit, based on determining the total category amount and to a user device associated with the user, user interface data, associated with a multi-tab user interface element for a display of the user device, including:
a plurality of tabs corresponding to the plurality of categories and associated with benefits information associated with the user account, and
an action button associated with a first category of the plurality of categories;
receive, from the user device, information indicating a selection of the action button;
determine, based on receiving the information indicating the selection of the action button, benefits information associated with the first category using a machine model and based on geographical information associated with the user device and historical interaction amounts of the user; and
transmit, to the user device, updated user interface data, associated with the multi-tab user interface element, indicating the benefits information.

17. The non-transitory computer-readable medium of claim 16, wherein the one or more instructions further cause the device to:
obtain interaction data associated with a plurality of interactions, including the one or more interactions, with a plurality of third parties across the plurality of categories, wherein the interaction data includes an account identifier of the one or more account identifiers; and
categorize, based on the interaction data, the plurality of interactions according to the plurality of categories.

18. The non-transitory computer-readable medium of claim 17, wherein the interaction data comprises an interaction amount and an interaction time, and wherein the plurality of interactions are categorized based on one or more rules associated with the interactions amount and the interaction time.

19. The non-transitory computer-readable medium of claim 17, wherein the interaction data comprises third party information associated with a third party of the plurality of third parties, and wherein the plurality of interactions are categorized based on one or more rules associated with the third party information.

20. The non-transitory computer-readable medium of claim 17, wherein the interaction data is obtained from a plurality of terminals receiving the plurality of interactions.
